(19) United States
(12) Patent Application Publication
(10) Pub. No.: US 2024/0290100 A1
(43) Pub. Date: Aug. 29, 2024

(54) SECURITY AND GUARD SYSTEM

(71) Applicant: InnoLux Corporation, Miao-Li County (TW)

(72) Inventors: Chih-Yang CHEN, Miao-Li County (TW); I-An YAO, Miao-Li County (TW)

(21) Appl. No.: 18/416,066

(22) Filed: Jan. 18, 2024

Related U.S. Application Data
(60) Provisional application No. 63/447,764, filed on Feb. 23, 2023.

(30) Foreign Application Priority Data
Nov. 1, 2023 (CN) 202311440872.5

(51) Int. Cl. G06V 20/52; G06V 10/74; H04N 23/11; H04N 23/695

(52) U.S. Cl. CPC G06V 20/52; G06V 10/761; H04N 23/11; H04N 23/695

(57) ABSTRACT

A security and guard system is used to monitor an area. The area is divided into at least a first block and at least a second block. The security and guard system includes at least one infrared light sensor, at least one camera, and a control host. The infrared light sensor senses the entire range of the area. The camera captures partial range of the area. The control host is connected to the infrared light sensor and the camera and, according to a heat source sensed by the infrared light sensor, controls the camera to capture an image corresponding to the sensed heat source, wherein, according to whether the sensed heat source is in the first block or in the second block, the control host performs different security and guard responses.

### CROSS-REFERENCE TO RELATED APPLICATIONS

This application claims the benefit of filing date of U.S. Provisional Application Ser. No. 63/447,764 filed on Feb. 23, 2023 under 35 USC § 119(e)(1), and also claims the benefit of the Chinese Patent Application Serial Number 202311440872.5, filed on Nov. 1, 2023, the subject matters of which are incorporated herein by reference.

### BACKGROUND

### Field of the Disclosure

The present disclosure relates to a security and guard system and, more specifically, to a security and guard system that integrates infrared thermal imaging and optical cameras.

### Description of Related Art

At present, most home security and guard systems are optical monitoring systems, which use wide-angle cameras to carry out large-area, full-coverage passive surveillance, with fixed-speed mechanical rotation scanning supplemented to increase the coverage area, while a small number of the systems are provided with near-infrared lights as auxiliary lighting for low light source.

However, in the optical surveillance system, there are many contradictions that are difficult to overcome. For example, in order to cover a large area of the surveillance area, it is impossible to take a high-resolution photograph for a specific target, and the lack of high-resolution images makes image recognition difficult. If high-resolution photography is used, the range of photographing is inevitably limited, and thus it is difficult to completely cover the surveillance area, resulting in many blind spots. In order to make up for the blind spots of photographing and cover the surveillance area as much as possible, the amount of data generated is too large and contains a lot of redundant information.

Therefore, it is desired to provide an improved security and guard system to mitigate and/or obviate the aforementioned problems.

### SUMMARY

The present disclosure provides a security and guard system for monitoring an area divided into at least one first block and at least one second block, which comprises: at least one infrared light sensor for sensing a first range of the area; at least one camera for photographing a second range of the area, wherein the first range is larger than the second range; a control host connected to the at least one infrared light sensor and the at least one camera and using a heat source sensed by the at least one infrared light sensor to selectively control the at least one camera to capture an optical image corresponding to the sensed heat source, wherein the control host performs different security and guard responses according to whether the sensed heat source is located in the first block or in the second block.

Other novel features of the disclosure will become more apparent from the following detailed description when taken in conjunction with the accompanying drawings.

### BRIEF DESCRIPTION OF DRAWINGS

FIG. 1 is a schematic diagram of the security and guard system in monitoring an area according to an embodiment of the present disclosure;

FIG. 2 schematically illustrates the configuration of the security and guard system according to an embodiment of the present disclosure;

FIG. 3 is a schematic structural diagram of the security and guard system according to an embodiment of the present disclosure;

FIG. 4 is a schematic diagram of the work flow of the security and guard system in a normal state according to an embodiment of the present disclosure; and

FIG. 5 is a schematic diagram of the work flow of the security and guard system in an alert state according to an embodiment of the present disclosure.

### DETAILED DESCRIPTION OF EMBODIMENT

Different embodiments of the present disclosure are provided in the following description. These embodiments are meant to explain the technical content of the present disclosure, but not meant to limit the scope of the present disclosure. A feature described in an embodiment may be applied to other embodiments by suitable modification, substitution, combination, or separation.

It should be noted that, in the present specification, when a component is described to “comprise”, “have”, “include” an element, it means that the component may include one or more of the elements, and the component may include other elements at the same time, and it does not mean that the component has only one of the element, except otherwise specified.

Moreover, in the present specification, the ordinal numbers, such as “first” or “second”, are only used to distinguish a plurality of elements having the same name, and it does not means that there is essentially a level, a rank, an executing order, or an manufacturing order among the elements, except otherwise specified. The ordinal numbers of the elements in the specification may not be the same in claims. For example, a “second” element in the specification may be a “first” element in the claims.

In the present specification, except otherwise specified, the feature A “or” or “and/or” the feature B means only the existence of the feature A, only the existence of the feature B, or the existence of both the features A and B. The feature A “and” the feature B means the existence of both the features A and B.

Moreover, in the present specification, the terms, such as “top”, “upper”, “bottom”, “front”, “back”, or “middle”, as well as the terms, such as “on”, “above”, “over”, “under”, “below”, or “between”, are used to describe the relative positions among a plurality of elements, and the described relative positions may be interpreted to include their translation, rotation, or reflection.

Furthermore, the terms recited in the specification and the claims such as “above”, “over”,” on”,” below”, or” under” are intended that an element may not only directly contacts other element, but also indirectly contact the other element.

Furthermore, the term recited in the specification and the claims such as “connect” is intended that an element may not only directly connect to other element, but also indirectly connect to other element. On the other hand, the terms recited in the specification and the claims such as “electrically connect” and “couple” are intended that an element may not only directly electrically connect to other element, but also indirectly electrically connect to other element.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those skilled in the art, the background of the present disclosure or the context of the present specification, and should not be read by an ideal or over-formal way.

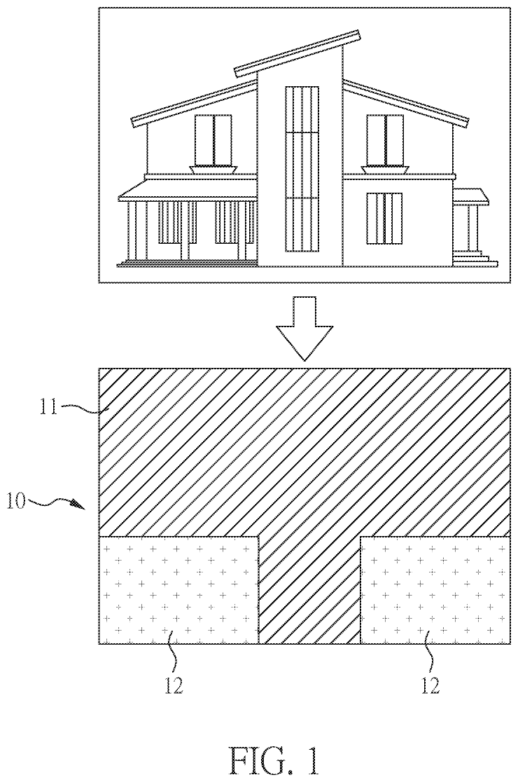

FIG. 1 shows a schematic diagram of a security and guard system in monitoring an area according to an embodiment of the present disclosure. As shown in FIG. 1, the security and guard system of the present application is used to monitor an area 10. The monitored area 10 may be divided into at least one first block 11 and at least one second block 12. For convenience of description, FIG. 1 shows that the area 10 monitored by the security and guard system is a range where a house is located, while this is only an example but not a limitation. It is conceivable that the area 10 monitored may also be a factory area, an office area, a shopping mall, a warehouse place, etc. The monitored area 10 is divided into a first block 11 and two second blocks 12. The first block 11 is an alert zone, and the second block 12 is a non-alert zone. The non-alert zone may be defined as the range of daily activities of permitted users (such as but not limited to residents, employees, tourists, etc.), which may be, for example, the driveway, doorway, etc. of the house, while it is not limited thereto. The alert zone may be defined as the non-frequent activity range of permitted users (such as but not limited to residents, employees, tourists, etc.), which may be, for example, the walls, roofs, windowsills, etc. of the house, while it is not limited thereto.

In one embodiment, the alert zone and the non-alert zone may be preset by the user in the security and guard system. However, in another embodiment, the alert zone and the non-alert zone may also be automatically set or adjusted by the security and guard system based on the historical data of monitoring, while it is not limited thereto.

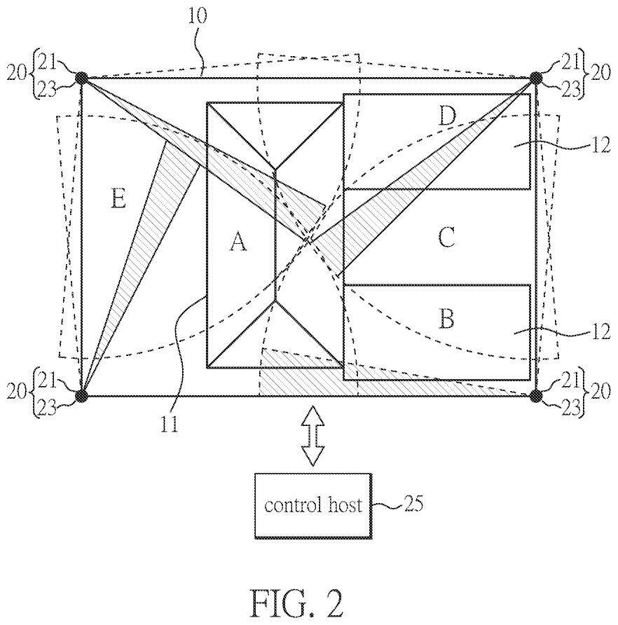

FIG. 2 schematically illustrates the configuration of the security and guard system according to an embodiment of the present disclosure. As shown in FIG. 2, the area 10 monitored by the security and guard system includes, for example, a main house (indicated by A), a parking space (indicated by B), a front yard (indicated by C), a doorway (indicated by D), and a backyard (indicated by E), wherein the parking space and the doorway may be set as non-alert zones, and the front yard, the backyard and the walls, roofs, windowsills, etc. of the main house may be set as alert zones, while this is only an example and the present disclosure is not limited thereto. The security and guard system includes at least one infrared light sensor 21, at least one camera 23 and a control host 25. For convenience of description, in FIG. 2, the security and guard system is exemplified by including four infrared light sensors 21 and four cameras 23 (the present disclosure is not limited thereto), and one infrared light sensor 21 and one camera 23 may constitute a monitoring unit 20, while four monitoring units 20 are arranged at the four corners of the area 10. With such a configuration, since the infrared light sensor 21 may sense a larger coverage area (as shown in the fan-shaped dotted frame in FIG. 2), the infrared light sensors 21 disposed at the four corners of the area 10 may sense the entire range of the area 10, or even beyond the boundaries of the area 10 to achieve an early warning effect. However, since the camera 23 is limited in the field of view that can be photographed, the cameras 23 disposed at the four corners of the area 10 may photograph partial range of the area 10 under a normal condition (as shown by the slash range in FIG. 2) and, with the control host 25 that controls the rotation and elevation angles of the cameras 23, the cameras 23 may be controlled to photograph the entire range that can be sensed by the infrared light sensors 21, and the field of view may be clear enough to obtain all or partial features of persons or objects for successful recognition. In other words, the infrared light sensors 21 may be used to sense a first range of the area 10, and the cameras 23 may be used to photograph a second range of the area 10, wherein the first range is larger than the second range. In addition, the cameras 23 may also be turned off or in a standby state in a normal state, and may be started or restored to the working state by the control host 25, while it is not limited thereto.

In one embodiment, the control host 25 may be disposed in the area 10, such as in the house. However, in another embodiment, the control host 25 may also be disposed outside the area 10, such as in a cloud server, or the control host 25 itself is a cloud server, while it is not limited thereto.

In one embodiment, the type of infrared light sensor 21 may include a long wave infrared (LWIR) sensor, a short wave infrared (SWIR) sensor, a middle wave infrared (MWIR) sensor or a far infrared (FIR) sensor, or a combination thereof, while it is not limited thereto. For convenience of description, in the present disclosure, the infrared light sensor 21 is exemplified mainly by a long wave infrared light sensor. In one embodiment, the infrared light sensor 21 may be used to sense the image characteristics of a heat source in its sensing area, such as, but not limited to, the outline of the heat source.

In one embodiment, the type of camera 23 may include an optical camera or a near infrared (NIR) camera, while it is not limited thereto. In one embodiment, the camera 23 may be used to obtain an optical image that approximates a real image, while it is not limited thereto.

In one embodiment, the infrared light sensor 21 may perform detection for a long time, and the camera 23 may perform detection for a short time. For example, the camera 23 may remain in a shutdown or standby state most of the time and, when the control host 25 determines that the heat source sensed by the infrared light sensor 21 reaches a specific condition, the control host 25 starts or restores the working state of the camera 23 for photographing, while it is not limited thereto. In one embodiment, the infrared light sensor 21 and the camera 23 may be set to perform sensing or photographing at a fixed point, fixed timing or fixed direction, but it is not limited thereto. In one embodiment, the camera 23 may be provided with a steering function. For example, when the control host 25 determines that the camera 23 has to be used to photograph the heat source in a specific direction detected by the infrared light sensor 21, the control host 25 may control the camera 23 to rotate for being adjusted to an angle suitable for photographing, while it is not limited thereto. In other words, based on the heat source sensed by the infrared light sensor 21, the control host 25 may selectively control the camera 23 to capture an optical image corresponding to the sensed heat source, wherein “selectively control” refers to that, for example, the host 25 may select whether to enable the camera 23 to perform photographing or not according to the sensed heat source, while it is not limited thereto.

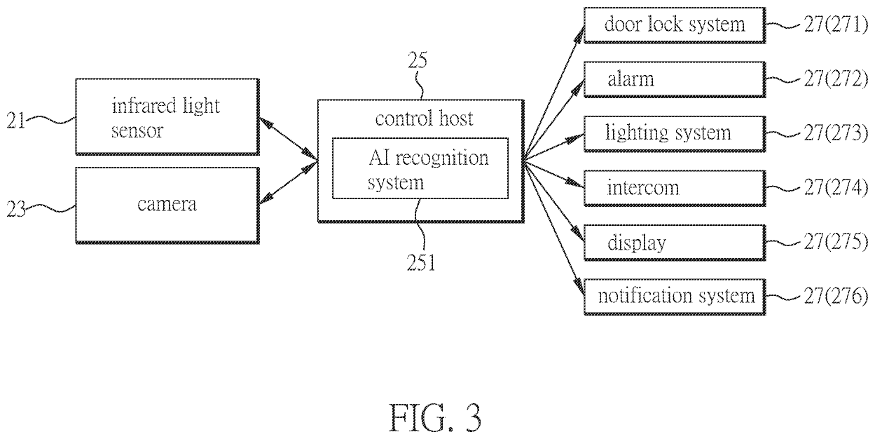

FIG. 3 shows a schematic structural diagram of a security and guard system according to an embodiment of the present disclosure. As shown in FIG. 3, in addition to the infrared light sensor 21, the camera 23 and the control host 25 shown in FIG. 2, the security and guard system further includes at least one component 27 connected to the control host 25 in a wired or wireless manner. In one embodiment, the type of the component 27 may include a door lock system 271, an alarm 272, a lighting system 273, an intercom 274, a display 275 or a notification system 276, etc., or a combination thereof, while it is not limited thereto. In fact, the present disclosure may include more or fewer types of components 27. The components 27 may be used to perform various security and guard responses. The aforementioned door lock system 271, alarm 272, lighting system 273, intercom 274, display 275 and notification system 276 may be installed inside the house, outside the house, or a proper location at a remote site. In one embodiment, the control host 25 may further have an artificial intelligence (AI) recognition system 251 to provide various recognitions related to security and guard by using artificial intelligence technology. For example, it may be used to perform various image recognitions suitable for the present disclosure, while it is not limited thereto. In one embodiment, the component 27 may be controlled by the control host 25 through the Internet of Things (IoT), while it is not limited thereto.

In one embodiment, the control host 25 may be connected to the infrared light sensor 21 and the camera 23 in a wired or wireless manner. Therefore, when the infrared light sensor 21 senses the occurrence of a heat source, the control host 25 may determine whether the sensed heat source is located in the first block 11 or in the second block 12, and/or compute the image characteristics of the sensed heat source (such as but not limited to the heat source contour or the heat source temperature), and/or further control the rotation and elevation angle of the camera 23 based on the sensed heat source, so as to capture images (such as but not limited to optical images) corresponding to the sensed heat source, so that the camera 23 may photograph the entire range of infrared light sensing. Therefore, the control host 25 may perform different security and guard responses based on the aforementioned information. Specifically, the control host 25 may perform different security and guard responses according to whether the sensed heat source is located in the first block 11 or in the second block 12. Furthermore, the control host 25 may perform different security and guard responses according to the image characteristics of the sensed heat source, and whether the sensed heat source is located in the first block 11 or in the second block 12. Furthermore, the control host 25 may perform different security and guard responses according to the image characteristics of the sensed heat source, the optical image corresponding to the sensed heat source, and whether the sensed heat source is located in the first block 11 or in the second block 12.

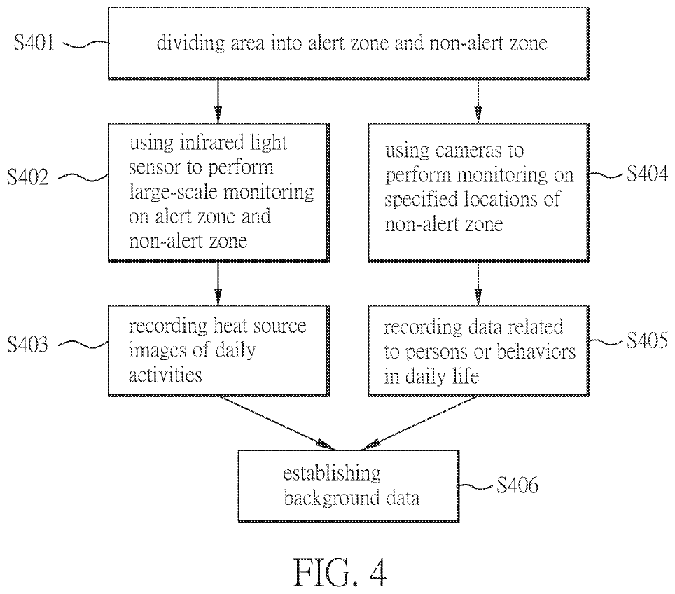

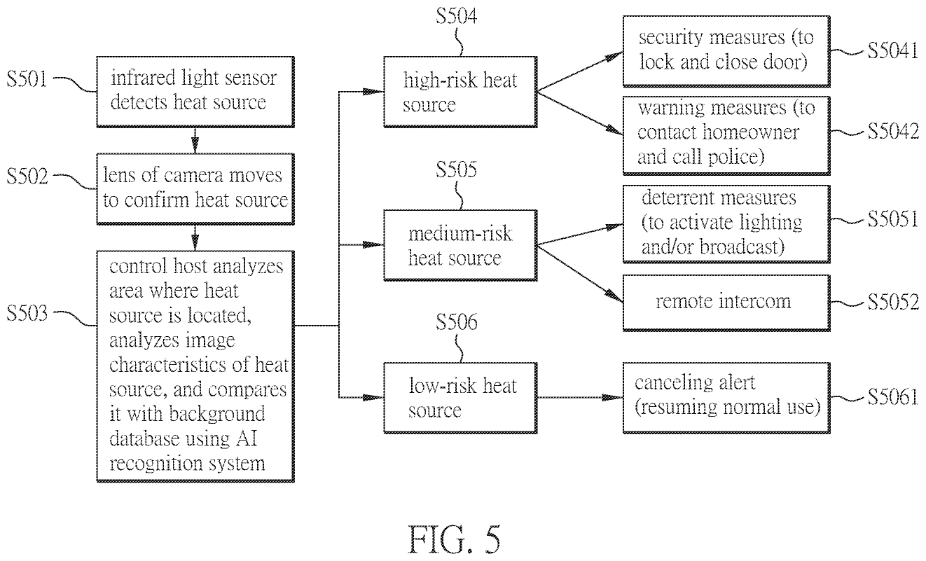

To illustrate the security and guard response performed by the security and guard system of the present disclosure, please refer to FIG. 4 and FIG. 5, wherein FIG. 4 is a schematic diagram of the work flow of the security and guard system in a normal state according to an embodiment of the present disclosure, and FIG. 5 is a schematic diagram of the work flow of the security and guard system in an alert state according to an embodiment of the present disclosure.

As shown in FIG. 4, in the normal state of the security system, according to the user's settings or default settings, the security and guard system first divides the entire monitoring area 10 into at least one alert zone (that is, the first block 11) and at least one non-alert zone (that is, the second block 12) (step S401), wherein the non-alert zone is, for example, the daily activity area of the residents, such as the driveway, doorway, etc., and the alert zone is, for example, the non-frequent activity area of the residents, such as the walls, roofs, windowsills, etc. Next, the security and guard system uses the infrared light sensor 21 to perform large-scale monitoring on the alert zone and the non-alert zone (step S402), and records the heat source images of daily activities (step S403). In addition, the security and guard system uses cameras to perform monitoring on specified locations of the non-alert zone (step S404), and the security and guard system records data related to persons or behaviors in daily life (step S405), whereby background data is established to form a background database for being used by the control host 25 to perform security and guard actions (step S406).

In one embodiment, the control host 25 may determine the risk level of the heat source, for example, classify the heat source into a high-risk heat source, a medium-risk heat source and a low-risk heat source, and perform different security responses according to the different risk levels of the heat source.

In one embodiment, the background data may be used as a basis for the control host 25 to determine whether the heat source is a suspicious heat source. In one embodiment, the background data may include pre-stored heat source images of permitted users, optical images of permitted users, or a combination thereof, while it is not limited thereto. Therefore, in one embodiment, when the infrared light sensor 21 senses a heat source, the control host 25 may compare the heat source with the heat source images of permitted users in the background data to determine whether the heat source is a permitted user. Alternatively, in another embodiment, when the camera 23 captures an optical image corresponding to the heat source sensed by the infrared light sensor 21, the control host 25 may compare the optical image with the optical images of the permitted users in the background data to determine whether the heat source is a permitted user. In addition, in one embodiment, the control host 25 may analyze the data obtained by the infrared light sensor 21 or the camera 23 under long-term operation, and the background data may include behavior information of permitted users (such as daily routines) or the daily heat source distribution in the area 10, so that, when the control host 25 determines the risk level of the heat source, the behavior information of permitted users or the daily heat source distribution in the area 10 may be used as the basis for auxiliary judgment. For example, if a permitted user appears in a specific area during a specific time period, when the infrared light sensor 21 senses that there is a heat source in the specific area during the specific period, the probability of the control host 25 determining that the heat source is a permitted user will be increased, while it is not limited thereto. In addition, the control host 25 may also automatically set the alert zone (first block 11) and non-alert zone (second block 12) of the area 10 based on the behavior information of permitted users or the daily heat source distribution in the area 10, while it is not limited thereto.

In one embodiment, the background database may be set in a storage device of the control host 25 itself, but may also be set in a storage device of a cloud server outside the security and guard system, wherein the type of storage device may, for example, include memory or hard drive, while it is not limited thereto.

Furthermore, in one embodiment, as shown in FIG. 5, the security and guard system is in an alert state and, when the infrared light sensor 21 detects a heat source (step S501), the control host 25 controls the lens of the camera 23 to move to confirm the heat source (step S502). Then, the control host 25 analyzes the area where the heat source is located, analyzes the image characteristics of the heat source, and compares it with the background database using the AI recognition system 251 (step S503) so as to determine the risk level of the heat source. When the sensed heat source is located in the first block 11, the image characteristics of the sensed heat source match the image characteristics of a person, and the optical image corresponding to the sensed heat source is a non-permitted person (such as not a resident of the house, or other persons who have not been approved in advance to enter the house), the control host 25 determines that the sensed heat source is a high-risk heat source (step S504) and, at this moment, the security and guard response performed by the control host 25 includes security measures to lock and close the door (step S5041), and/or warning measures to contact the homeowner and call the police (step S5042). In one embodiment, the AI recognition system 251 may determine whether the heat source is a non-permitted person and/or a high-risk heat source based on the temperature, contour, shape or size of the heat source sensed by the infrared light sensor 21, or the optical image obtained by the camera 23, or a combination thereof, while it is not limited thereto.

When the sensed heat source is located in the first block 11 and the image characteristics of the sensed heat source do not match the image characteristics of a person, or the sensed heat source is located in the second block 12 and the image characteristics of the sensed heat source match the image characteristics of a person and the optical image corresponding to the sensed heat source is a non-permitted person, the control host 25 determines that the sensed heat source is a medium-risk heat source (step S505). At this moment, the security and guard response performed by the control host includes deterrent measures to activate lighting and/or broadcast (step S5051), and/or remote intercom (step S5052). In one embodiment, the AI recognition system 251 may determine whether the heat source is a non-permitted person and/or a medium-risk heat source based on the temperature, contour, shape or size of the heat source sensed by the infrared light sensor 21, or the optical image obtained by the camera 23, or a combination thereof, while it is not limited thereto.

When the sensed heat source is located in the second block 12, the image characteristics of the sensed heat source match the image characteristics of a person, and the optical image corresponding to the sensed heat source is a permitted person (such as a resident of the house or other persons who have been pre-approved to enter the house), the control host 25 determines that the sensed heat source is a low-risk heat source (step S506). At this moment, the security and guard response performed by the control host 25 includes canceling the alert (resuming normal use) (step S5061). In one embodiment, the AI recognition system 251 may determine whether the heat source is a permitted person and/or a low risk heat source based on the temperature, contour, shape or size of the heat source sensed by the infrared light sensor 21, or the optical image obtained by the camera 23, or a combination thereof, while it is not limited thereto.

From the above description, it can be seen that, in the security and guard system of the present disclosure, infrared light detection and high-precision photographing are used, in cooperation with AI recognition, to proactively respond and counterattack possible security and guard crises at the beginning. Alternatively, the security and guard system of the present disclosure can reduce the large amount of redundant recording data generated by passive systems. Alternatively, the security and guard system of the present disclosure can provide early warning of possible dangers for early countermeasures, so as to deal with security and guard events immediately, thereby reducing the cost required for the security and guard events.

In one embodiment, the present disclosure may at least determine whether a product in contention falls within the protection scope of the present disclosure based on the presence or absence of components, component configurations and/or operating modes of the product in contention, or may determine whether a product in contention falls within the protection scope of the present disclosure based on the algorithm of the product in contention, while it is not limited thereto. In one embodiment, the algorithm of the product in contention may be obtained, for example, through reverse engineering, while it is not limited thereto.

The features of the various embodiments of the present disclosure may be mixed and matched arbitrarily as long as they do not violate the spirit of the present disclosure or conflict with each other.

The aforementioned specific embodiments should be interpreted as merely illustrative, and not limiting the rest of the present disclosure in any way, and the features of different embodiments may be mixed and matched as long as they do not conflict with each other.

1. A security and guard system for monitoring an area divided into at least one first block and at least one second block, comprising:
at least one infrared light sensor for sensing a first range of the area;
at least one camera for photographing a second range of the area, wherein the first range is larger than the second range; and
a control host connected to the at least one infrared light sensor and the at least one camera and using a heat source sensed by the at least one infrared light sensor to selectively control the at least one camera to capture an optical image corresponding to the sensed heat source,
wherein the control host performs different security and guard responses according to whether the sensed heat source is located in the first block or in the second block.

2. The security and guard system as claimed in claim 1, wherein the first block is an alert zone and the second block is a non-alert zone.

3. The security and guard system as claimed in claim 2, wherein the control host performs different security and guard responses according to image characteristics of the sensed heat source, and whether the sensed heat source is located in the first block or in the second block.

4. The security and guard system as claimed in claim 2, wherein the control host performs different security and guard responses according to image characteristics of the sensed heat source, an optical image corresponding to the sensed heat source, and whether the sensed heat source is located in the first block or in the second block.

5. The security and guard system as claimed in claim 4, wherein, when the sensed heat source is located in the first block, the image characteristics of the sensed heat source match image characteristics of a person, and the optical image corresponding to the sensed heat source is a non-permitted person, the control host determines that the sensed heat source is a high-risk heat source.

6. The security and guard system as claimed in claim 5, wherein the security and guard response performed by the control host includes locking and closing doors or contacting owners and calling police.

7. The security and guard system as claimed in claim 4, wherein, when the sensed heat source is located in the first block and the image characteristics of the sensed heat source do not match image characteristics of a person, or when the sensed heat source is located in the second block, the image characteristics of the sensed heat source match image characteristics of a person and the optical image corresponding to the sensed heat source is a non-permitted person, the control host determined that the sensed heat source is a medium-risk heat source.

8. The security and guard system as claimed in claim 7, wherein the security and guard response performed by the control host includes activating lighting, broadcasting, or remote intercom.

9. The security and guard system as claimed in claim 4, wherein, when the sensed heat source is located in the second block, the image characteristics of the sensed heat source match image characteristics of a person, and the optical image corresponding to the sensed heat source is a permitted person, the control host determines that the sensed heat source is a low-risk heat source.

10. The security and guard system as claimed in claim 9, wherein the security response performed by the control host includes canceling the alert.

11. The security and guard system as claimed in claim 1, wherein the control host controls rotation and elevation angles of the at least one camera so that the at least one camera is controlled to photograph entire range that can be sensed by the at least one infrared light sensor.

12. The security and guard system as claimed in claim 1, wherein the at least one camera is in a shutdown or standby state in a normal state, and is started or restored to a working state by the control host.

13. The security and guard system as claimed in claim 12, wherein, when determining that the sensed heat source reaches a specific condition, the control host starts or restores the working state of the at least one camera for photographing.

14. The security and guard system as claimed in claim 1, wherein the control host further uses the at least one camera to perform monitoring on specified locations of the second block, and records data of persons or behaviors in daily life, so as to create background data for forming a background database.

15. The security and guard system as claimed in claim 14, wherein the control host is further provided with an artificial intelligence recognition system to provide various recognitions related to security and guard by using artificial intelligence technology.

16. The security and guard system as claimed in claim 15, wherein the control host analyzes an area where the sensed heat source is located, and analyzes the image characteristics of the sensed heat source for being compared with the background database by using the artificial intelligence recognition system to determine a risk level of the sensed heat source.

17. The security and guard system as claimed in claim 14, wherein the background data includes pre-stored heat source images of permitted users, optical images of permitted users, or a combination thereof.

18. The security and guard system as claimed in claim 17, wherein, when the at least one infrared light sensor senses a heat source, the control host compares the sensed heat source with the heat source images of permitted users in the background data to determine whether the sensed heat source is a permitted user.

19. The security and guard system as claimed in claim 17, wherein, when the at least one camera captures an optical image of the sensed heat source, the control host compares the optical image with the optical images of permitted users in the background data to determine whether the sensed heat source is a permitted user.

20. The security and guard system as claimed in claim 1, further comprising at least one component connected to the control host in a wired or wireless manner, and the at least one component includes a door lock system, an alarm, a lighting system, an intercom, a display or a notification system, or a combination thereof.
